(19) United States
(12) Patent Application Publication
(10) Pub. No.: US 2015/0198920 A1
(43) Pub. Date: Jul. 16, 2015

(54) FIXING DEVICE AND IMAGE FORMING APPARATUS

(71) Applicants: Yoshihiro FUKUHATA, Hyogo (JP); Yuusuke FURUICHI, Osaka (JP)

(72) Inventors: Yoshihiro FUKUHATA, Hyogo (JP); Yuusuke FURUICHI, Osaka (JP)

(21) Appl. No.: 14/587,273

(22) Filed: Dec. 31, 2014

(30) Foreign Application Priority Data
Jan. 16, 2014 (JP) 2014-005627

(51) Int. Cl. G03G 15/20

(52) U.S. Cl. CPC G03G 15/2085

(57) ABSTRACT

A fixing device includes an endless fixing rotator rotatable in a predetermined direction of rotation and a heater disposed opposite the fixing rotator to heat the fixing rotator. A pressure rotator is pressed against an outer circumferential surface of the fixing rotator to drive and rotate the fixing rotator. A nip formation member presses against the pressure rotator via the fixing rotator to form a fixing nip between the fixing rotator and the pressure rotator, through which a recording medium bearing a toner image is conveyed. The nip formation member supports the fixing rotator. A driving rotator supporting the fixing rotator drives and rotates the fixing rotator. The driving rotator rotates at a circumferential speed greater than a circumferential speed of the pressure rotator.

### CROSS-REFERENCE TO RELATED APPLICATION

This patent application is based on and claims priority pursuant to 35 U.S.C. §119 to Japanese Patent Application No. 2014-005627, filed on Jan. 16, 2014, in the Japanese Patent Office, the entire disclosure of which is hereby incorporated by reference herein.

### BACKGROUND

1. Technical Field

Exemplary aspects of the present disclosure relate to a fixing device and an image forming apparatus, and more particularly, to a fixing device for fixing a toner image on a recording medium and an image forming apparatus incorporating the fixing device.

2. Description of the Background

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such fixing device may include a fixing rotator, such as a fixing roller, a fixing belt, and a fixing film, heated by a heater and a pressure rotator, such as a pressure roller and a pressure belt, pressed against the fixing rotator to form a fixing nip therebetween through which a recording medium bearing a toner image is conveyed. As the recording medium bearing the toner image is conveyed through the fixing nip, the fixing rotator and the pressure rotator apply heat and pressure to the recording medium, melting and fixing the toner image on the recording medium.

### SUMMARY

This specification describes below an improved fixing device. In one exemplary embodiment, the fixing device includes an endless fixing rotator rotatable in a predetermined direction of rotation and a heater disposed opposite the fixing rotator to heat the fixing rotator. A pressure rotator is pressed against an outer circumferential surface of the fixing rotator to drive and rotate the fixing rotator. A nip formation member presses against the pressure rotator via the fixing rotator to form a fixing nip between the fixing rotator and the pressure rotator, through which a recording medium bearing a toner image is conveyed. The nip formation member supports the fixing rotator. A driving rotator supporting the fixing rotator drives and rotates the fixing rotator. The driving rotator rotates at a circumferential speed greater than a circumferential speed of the pressure rotator.

This specification further describes an improved image forming apparatus. In one exemplary embodiment, the image forming apparatus includes an image forming device to form a toner image on a recording medium and a fixing device, disposed downstream from the image forming device in a recording medium conveyance direction, to fix the toner image on the recording medium. The fixing device includes an endless fixing rotator rotatable in a predetermined direction of rotation and a heater disposed opposite the fixing rotator to heat the fixing rotator. A pressure rotator is pressed against an outer circumferential surface of the fixing rotator to drive and rotate the fixing rotator. A nip formation member presses against the pressure rotator via the fixing rotator to form a fixing nip between the fixing rotator and the pressure rotator, through which the recording medium bearing the toner image is conveyed. The nip formation member supports the fixing rotator. A driving rotator supporting the fixing rotator drives and rotates the fixing rotator. The driving rotator rotates at a circumferential speed greater than a circumferential speed of the pressure rotator.

### BRIEF DESCRIPTION OF THE DRAWINGS

A more complete appreciation of the disclosure and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an exemplary embodiment of the present disclosure;

FIG. 2 is a schematic vertical sectional view of a fixing device incorporated in the image forming apparatus shown in FIG. 1;

FIG. 3 is a sectional view of a fixing belt incorporated in the fixing device shown in FIG. 2;

FIG. 4 is a schematic vertical sectional view of a driver incorporated in the image forming apparatus shown in FIG. 1;

FIG. 5 is a graph showing a relation between a circumferential speed ratio of a circumferential speed of a heating roller with respect to a circumferential speed of a pressure roller of the fixing device shown in FIG. 2 and a circumferential speed ratio of a circumferential speed of the fixing belt with respect to the circumferential speed of the pressure roller;

FIG. 6 is a schematic vertical sectional view of the fixing device shown in FIG. 2 illustrating the shape of the fixing belt; and

FIG. 7 is a schematic vertical sectional view of a fixing device according to another exemplary embodiment of the present disclosure.

### DETAILED DESCRIPTION OF THE DISCLOSURE

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner and achieve a similar result.

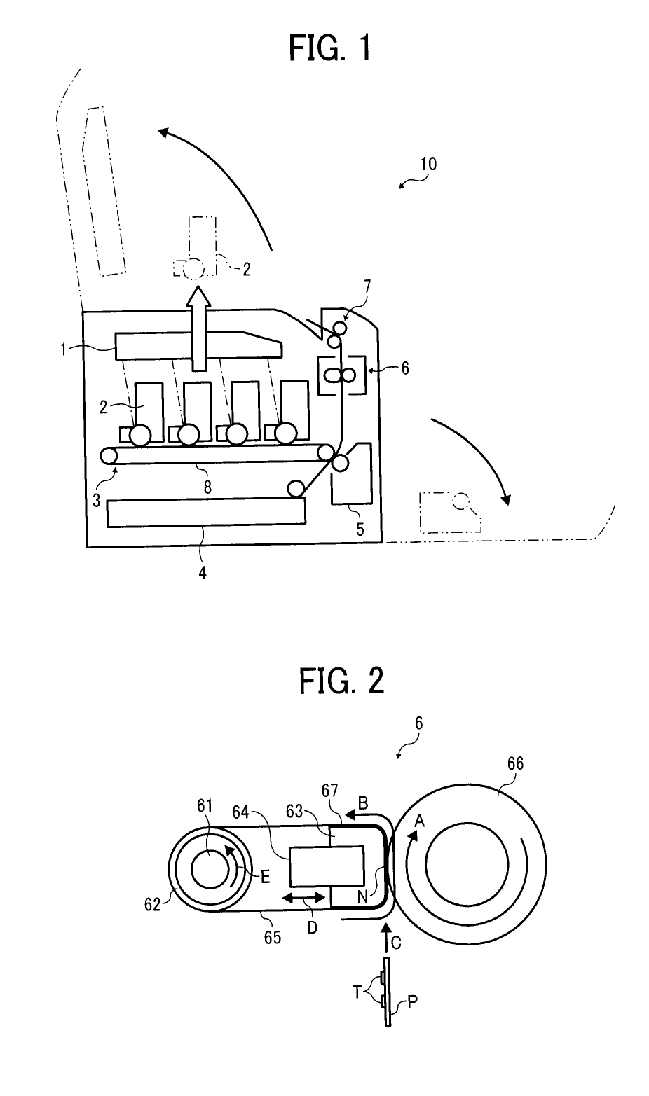

Referring now to the drawings, wherein like reference numerals designate identical or corresponding parts throughout the several views, in particular to FIG. 1, an image forming apparatus 10 according to an exemplary embodiment of the present disclosure is explained.

FIG. 1 is a schematic vertical sectional view of the image forming apparatus 10. The image forming apparatus 10 may be a copier, a facsimile machine, a printer, a multifunction peripheral or a multifunction printer (MFP) having at least one of copying, printing, scanning, facsimile, and plotter functions, or the like. According to this exemplary embodiment, the image forming apparatus 10 is a color printer that forms monochrome and color toner images on recording media by electrophotography.

With reference to FIG. 1, a description is provided of a construction of the image forming apparatus 10.

The image forming apparatus 10 is a tandem color image forming apparatus that forms color and monochrome toner images on recording media through electrophotographic image formation processes. The image forming apparatus 10 includes a writing device 1 serving as an optical writer or an exposure device and four process cartridges 2 serving as an image forming device containing toners in four colors, that is, black, cyan, magenta, and yellow, respectively. Toner may be pulverized toner or polymerization toner that contains oily silica, that is, silica containing oil, as an additive.

The image forming apparatus 10 further includes a primary transfer device 3 serving as a primary transferor; a sheet feeder 4 serving as a transfer sheet supply; a secondary transfer device 5 serving as a secondary transferor; a fixing device 6; and an output roller pair 7 serving as a transfer sheet ejector. The primary transfer device 3 includes an intermediate transfer belt 8 that bears black, cyan, magenta, and yellow toner images formed by the process cartridges 2, respectively, and superimposed on the intermediate transfer belt 8. The secondary transfer device 5 secondarily transfers the black, cyan, magenta, and yellow toner images constituting a color toner image primarily transferred onto the intermediate transfer belt 8 by the primary transfer device 3 onto a sheet serving as a transfer sheet or a recording medium. The sheet feeder 4 loads a plurality of sheets and supplies a sheet to a secondary transfer nip formed between the secondary transfer device 5 and the intermediate transfer belt 8. The fixing device 6 fixes the color toner image on the sheet. The output roller pair 7 ejects the sheet bearing the fixed color toner image onto an outside of the image forming apparatus 10. Each of the process cartridges 2, the primary transfer device 3, the sheet feeder 4, the secondary transfer device 5, and the fixing device 6 is a unit detachably attached to the image forming apparatus 10.

With reference to FIG. 2, a description is provided of a construction of the fixing device 6 incorporated in the image forming apparatus 10 described above.

FIG. 2 is a schematic vertical sectional view of a main section of the fixing device 6. As shown in FIG. 2, the fixing device 6 (e.g., a fuser or a fusing unit) includes a heating roller 62 serving as a driving rotator; a halogen heater 61 serving as a heater situated inside the heating roller 62; a fixing belt 65 serving as a fixing rotator or a fixing member; a pressure roller 66 serving as a pressure rotator or a pressure member driven and rotated by a driver in a rotation direction A; and a fixing pad 63 serving as a nip formation pad or a nip formation member. The fixing belt 65 is looped over and supported by the heating roller 62 and the fixing pad 63 that serve as a plurality of supports for supporting the fixing belt 65 such that the fixing belt 65 is rotatable in a rotation direction B. The pressure roller 66 is pressed against the fixing pad 63 via the fixing belt 65 to form a fixing nip N between the fixing belt 65 and the pressure roller 66. As a sheet P bearing a toner image T is conveyed through the fixing nip N, the fixing belt 65 heated by the heater 61 through the heating roller 62 and the pressure roller 66 apply heat and pressure to the sheet P, thus melting and fixing the toner image T on the sheet P.

Upstream from the fixing nip N in a sheet conveyance direction C is a conveyance guide that guides the sheet P to the fixing nip N. Downstream from the fixing nip N in the sheet conveyance direction C are a separator that separates the sheet P from the fixing belt 65 and a conveyance guide that guides the sheet P to the output roller pair 7 depicted in FIG. 1. Around the heating roller 62 are a temperature sensor contacting the fixing belt 65 to detect the temperature of a surface of the fixing belt 65 and a power breaker.

A detailed description is now given of a configuration of the heating roller 62.

The heating roller 62 is a hollow metal roller accommodating the halogen heater 61, thus heating the fixing belt 65 looped over the heating roller 62. The heating roller 62 includes a metal tube or pipe made of aluminum, iron, stainless steel, or the like. According to this exemplary embodiment, a 550-watt halogen heater is used as the halogen heater 61. An iron pipe having a diameter greater than an apparent diameter of the halogen heater 61 by about 1 mm is used as the heating roller 62. An inner circumferential surface of the heating roller 62 is treated with black coating to facilitate absorption of heat radiated from the halogen heater 61 and the like.

A detailed description is now given of a configuration of the halogen heater 61.

A power supply situated inside the image forming apparatus 10 supplies power to the halogen heater 61 so that the halogen heater 61 heats the heating roller 62. A controller (e.g., a processor), that is, a central processing unit (CPU) provided with a random-access memory (RAM) and a read-only memory (ROM), for example, operatively connected to the halogen heater 61 and the temperature sensor controls the halogen heater 61 based on the temperature of the surface of the fixing belt 65 detected by the temperature sensor. Thus, the temperature of the fixing belt 65 is adjusted to a desired fixing temperature. Alternatively, instead of the halogen heater 61, a resistance heat generator, a carbon heater, or the like may be employed as a heater that heats the fixing belt 65, if a decreased interval is provided between the heating roller 62 and the heater and a space is barely produced at a lateral end of the heating roller 62.

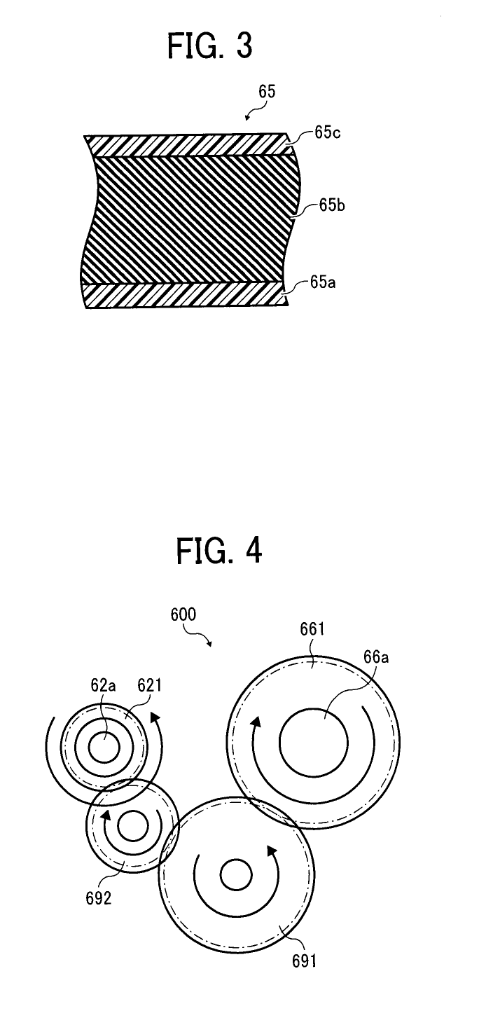

With reference to FIG. 3, a detailed description is now given of a configuration of the fixing belt 65.

FIG. 3 is a sectional view of the fixing belt 65. The fixing belt 65 is an endless belt or film made of resin such as polyimide, polyamide, and fluoroplastic or metal such as nickel and SUS stainless steel. As shown in FIG. 3, the fixing belt 65 includes a base layer 65a, an elastic layer 65b, and a release layer 65c. The surface release layer 65c is a resin layer made of tetrafluoroethylene-perfluoroalkylvinylether copolymer (PFA) or polytetrafluoroethylene (PTFE) to facilitate separation of toner of the toner image T on the sheet P from the fixing belt 65 and thus prevent toner from adhering to the fixing belt 65.

The elastic layer 65b, made of silicone rubber or the like, is sandwiched between the base layer 65a serving as a base and the surface release layer 65c. If the fixing belt 65 does not incorporate the elastic layer 65b, the fixing belt 65 has a decreased thermal capacity that enhances fixing property of being heated quickly to a predetermined fixing temperature at which the toner image T is fixed on the sheet P. However, the pressure roller 66 and the fixing belt 65 may not sandwich and press the toner image T on the sheet P passing through the fixing nip N evenly. Accordingly, as the sheet P is conveyed through the fixing nip N, slight surface asperities of the sheet P may be transferred onto the toner image T on the sheet P, producing an orange peel image on the sheet P. To address this circumstance, the elastic layer 65b made of silicone rubber or the like has a thickness not smaller than about 100 micrometers and not greater than about 0.5 mm. As the elastic layer 65b deforms, the elastic layer 65b absorbs slight surface asperities of the sheet P, preventing formation of the faulty orange peel image. According to this exemplary embodiment, the fixing belt 65 is constructed of the base layer 65a made of polyimide; the elastic layer 65b made of silicone rubber and having a thickness of about 180 micrometers; and a PFA tube coating the elastic layer 65b and having a thickness of about 20 micrometers.

A detailed description is now given of a configuration of the pressure roller 66.

As shown in FIG. 2, a pressure lever or the like biased by a spring presses the pressure roller 66 against the fixing pad 63 via the fixing belt 65. As an elastic layer of the pressure roller 66 is pressed and deformed, the pressure roller 66 produces the fixing nip N having a predetermined length in the sheet conveyance direction C. According to this exemplary embodiment, pressure exerted at the fixing nip N is not smaller than about 100 N and not greater than about 250 N as an A4 size sheet is conveyed through the fixing nip N. The pressure lever may move the pressure roller 66 to press the pressure roller 66 against the fixing pad 63 via the fixing belt 65 with decreased pressure or no pressure.

The pressure roller 66 is constructed of a hollow or solid metal roller; the thermally stable, elastic layer made of silicone rubber or the like; and a surface release layer made of PFA or PTFE to facilitate separation of the sheet P from the pressure roller 66. Silicone rubber of the elastic layer of the pressure roller 66 may be solid rubber or sponge rubber foam. The sponge rubber is more preferable than the solid rubber because it has an increased insulation that draws less heat from the fixing belt 65. If the pressure roller 66 is a hollow roller, a heater that heats the pressure roller 66 at the fixing nip N may be disposed inside the pressure roller 66. According to this exemplary embodiment, the elastic layer made of silicone rubber has a thickness of about 6 mm and produces a nip length of the fixing nip N of about 5 mm in the sheet conveyance direction C. No halogen heater is disposed inside the pressure roller 66 and the halogen heater 61 is disposed inside the heating roller 62.

A detailed description is now given of a configuration of the fixing pad 63.

The fixing pad 63 is supported by a fixing stay 64. As the fixing pad 63 slides over a groove of a side plate of the fixing stay 64, the fixing pad 63 is movable in a direction D in which the fixing pad 63 is disposed opposite the pressure roller 66. The fixing pad 63 is exerted with a load as the fixing pad 63 presses against the pressure roller 66. The fixing pad 63, made of an elastic body such as silicone rubber and fluoro rubber, heat resistant resin, or metal, is disposed opposite an inner circumferential surface of the fixing belt 65 via a slide sheet 67. Instead of the slide sheet 67, a contact face of the fixing pad 63 that contacts the fixing belt 65 may be coated with a slide aid layer that facilitates sliding of the fixing belt 65 over the fixing pad 63. According to this exemplary embodiment, the slide sheet 67 is sandwiched between the fixing belt 65 and the fixing pad 63 made of resin. A lubricant such as grease and silicone oil is interposed between the inner circumferential surface of the fixing belt 65 and the slide sheet 67.

The heating roller 62 and the pressure roller 66 are driven and rotated by a driving force transmitted from a driver (e.g., a motor) located inside the image forming apparatus 10 through a gear train or the like.

With reference to FIG. 4, a description is provided of a construction of a driver 600, that is, a driving force transmission system, which drives and rotates the heating roller 62 and the pressure roller 66.

FIG. 4 is a schematic vertical sectional view of the driver 600. As shown in FIG. 4, a pressure roller gear 661 serving as a driven gear mounted on a shaft 66a mounting the pressure roller 66 is driven by a driving force transmitted from a driving gear situated inside the image forming apparatus 10 through an idler gear 691 serving as a relay gear. A heating roller gear 621 serving as a driven gear mounted on a shaft 62a mounting the heating roller 62 is driven by a driving force transmitted through the idler gear 691 and an idler gear 692. The gear train differentiates a circumferential speed of the pressure roller 66 from a circumferential speed of the heating roller 62.

As shown in FIG. 2, as the pressure roller 66 is driven and rotated through the gear train, the driving force is transmitted to the fixing belt 65 at the fixing nip N, rotating the fixing belt 65 in accordance with rotation of the pressure roller 66. At the fixing nip N, the fixing belt 65 is rotated in the rotation direction B while it is sandwiched between the fixing pad 63 and the pressure roller 66. Conversely, at a position other than the fixing nip N, the fixing belt 65 is guided by the fixing pad 63. Pressure exerted by the pressure roller 66 to the fixing belt 65 is transmitted to the fixing belt 65, the slide sheet 67, and the fixing pad 63 in this order and received by the fixing pad 63 or the heating roller 62.

The fixing belt 65 is driven and rotated mostly by a driving force from the pressure roller 66. However, while a sheet P is sandwiched between the fixing belt 65 and the pressure roller 66, that is, during printing when the sheet P is conveyed through the fixing nip N, the fixing belt 65 may not convey the sheet P properly.

For example, as the fixing belt 65 slides over the fixing pad 63 as it rotates in the rotation direction B, the fixing belt 65 is imposed with a frictional load that decreases the circumferential speed of the fixing belt 65 compared to that of the pressure roller 66 at the fixing nip N, degrading motion of the fixing belt 65. Such degradation in motion of the fixing belt 65 may occur while the sheet P is sandwiched between the fixing belt 65 and the pressure roller 66. As the pressure roller 66 connected to the driver 600 receives a driving force from the driver 600, the driving force is transmitted from the pressure roller 66 to the sheet P in contact with the pressure roller 66 and further transmitted from the sheet P to the fixing belt 65 in contact with the sheet P. On the other hand, the fixing belt 65 is imposed with a frictional load as it slides over the fixing pad 63. Since motion of the fixing belt 65 is affected by transmission of the driving force from the pressure roller 66 and sliding of the fixing belt 65 over the fixing pad 63, when the sheet P is sandwiched between the fixing belt 65 and the pressure roller 66, motion of the fixing belt 65 may degrade substantially.

If motion of the fixing belt 65 degrades, a circumferential speed of the pressure roller 66 that conveys the sheet P may differ from a circumferential speed of the fixing belt 65 that conveys the sheet P, which is hereinafter called slippage of the sheet P. If the sheet P is not conveyed within a predetermined time due to slippage thereof, the controller determines that the sheet P is jammed and stops the fixing device 6. Additionally, slippage of the sheet P may cause faulty image noise.

In order to decrease friction between the fixing pad 63 and the fixing belt 65, the slide sheet 67 applied with the lubricant such as grease is interposed between the fixing pad 63 and the fixing belt 65. Alternatively, the fixing pad 63 may include a low friction layer. However, when the lubricant is consumed or the low friction layer of the fixing pad 63 suffers from abrasion, motion of the fixing belt 65 may degrade, resulting in slippage of the sheet P.

To address this circumstance, when motion of the fixing belt 65 is destabilized, the heating roller 62 does not rotate counterclockwise in FIG. 2 in a rotation direction E identical to the rotation direction B of the fixing belt 65 at an identical speed. Instead, the heating roller 62 rotates at a circumferential speed, that is, a surface movement speed, greater than a circumferential speed of the pressure roller 66. Accordingly, even when the sheet P is conveyed through the fixing nip N, motion of the fixing belt 65 does not degrade, suppressing slippage of the fixing belt 65 and the sheet P at the fixing nip N.

A description is provided of an experiment for examining motion of the fixing belt 65 while the sheet P is conveyed through the fixing nip N and while the sheet P is not conveyed through the fixing nip N.

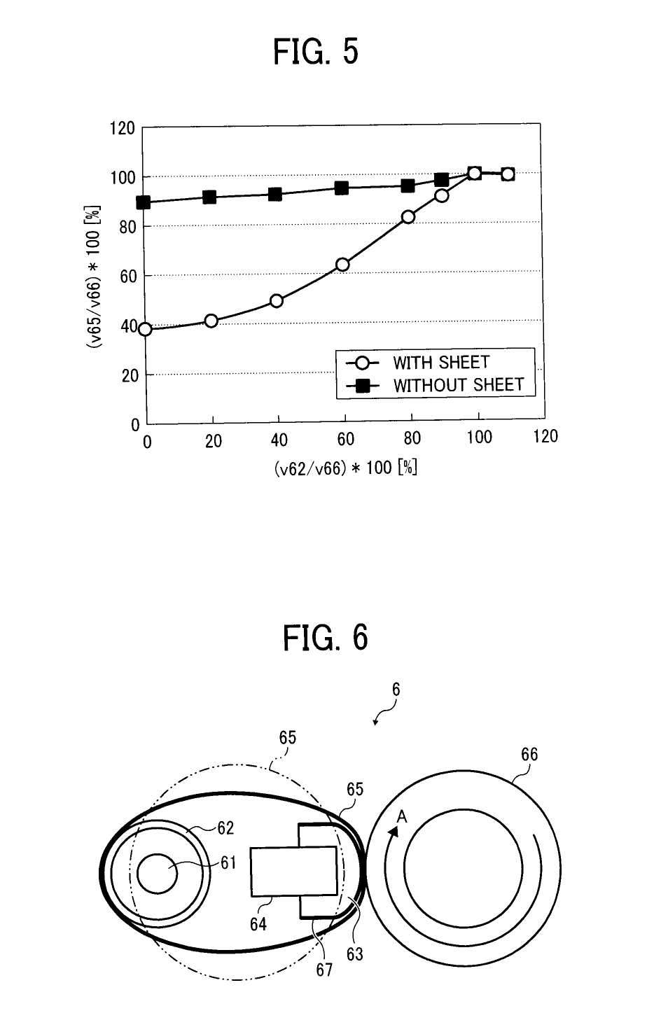

FIG. 5 is a graph showing a relation between a circumferential speed ratio of the circumferential speed of the heating roller 62 with respect to the circumferential speed of the pressure roller 66 and a circumferential speed ratio of the circumferential speed of the fixing belt 65 with respect to the circumferential speed of the pressure roller 66. In this experiment, hydrophobic silica (product name RY50 available from AEROSIL®) in an amount of 2 parts by weight was added to toner in an amount of 100 parts by weight and mixed for 5 minutes with a 20L Henschel mixer at a circumferential speed of 40 m/sec. Thereafter, the mixture was screened through a sieve with an aperture of 75 microns to obtain toner. The circumferential speed of the heating roller 62 and the pressure roller 66 was calculated based on the number of rotations and the radius thereof. The circumferential speed of the fixing belt 65 was calculated by measuring marking on the fixing belt 65 every turn and based on an elapsed time and the outer diameter of the fixing belt 65. The sheet P was plain paper, that is, thin paper having a smooth surface.

In this experiment, when the circumferential speed ratio of the circumferential speed of the fixing belt 65 with respect to the circumferential speed of the pressure roller 66 defined by a formula (1) below is 100 percent, motion of the fixing belt 65 is satisfactory.

r56=(v65/v66)×100 (1)

In the formula (1), r56 represents the circumferential speed ratio of the circumferential speed of the fixing belt 65 with respect to the circumferential speed of the pressure roller 66. v65 represents the circumferential speed of the fixing belt 65. v66 represents the circumferential speed of the pressure roller 66.

As shown in FIG. 5, when the circumferential speed ratio of the circumferential speed of the heating roller 62 with respect to the circumferential speed of the pressure roller 66 defined by a formula (2) below is 100 percent or more, motion of the fixing belt 65 is satisfactory regardless of whether or not the sheet P is conveyed through the fixing nip N.

r26=(v62/v66)×100 (2)

In the formula (2), r26 represents the circumferential speed ratio of the circumferential speed of the heating roller 62 with respect to the circumferential speed of the pressure roller 66. v62 represents the circumferential speed of the heating roller 62. v66 represents the circumferential speed of the pressure roller 66. Additionally, the experiment shows that slippage of the fixing belt 65 is prevented more precisely when the circumferential speed ratio of the circumferential speed of the heating roller 62 with respect to the circumferential speed of the pressure roller 66 is greater than 100 percent rather than when it is equal to 100 percent.

Conversely, the experiment shows that, when the circumferential speed ratio of the circumferential speed of the heating roller 62 with respect to the circumferential speed of the pressure roller 66 is not greater than 90 percent, slippage of the fixing belt 65 occurs regardless of whether or not the sheet P is conveyed through the fixing nip N. Additionally, when the circumferential speed ratio of the circumferential speed of the heating roller 62 with respect to the circumferential speed of the pressure roller 66 is greater than 110 percent, although no problem occurs initially, abrasion of the inner circumferential surface of the fixing belt 65 may accelerate due to difference in the circumferential speed between the heating roller 62 and the pressure roller 66 after long term use.

In order to retain precise motion of the fixing belt 65 and thereby prevent slippage of the sheet P, the circumferential speed of the heating roller 62 is greater than the circumferential speed of the pressure roller 66 and the circumferential speed ratio of the circumferential speed of the heating roller 62 with respect to the circumferential speed of the pressure roller 66 is not smaller than 101 percent and not greater than 110 percent. Even if the circumferential speed ratio of the circumferential speed of the heating roller 62 with respect to the circumferential speed of the pressure roller 66 is 100 percent, it is necessary to consider the outer diameter of the heating roller 62 and the pressure roller 66 and variation in the number of rotations of the heating roller 62 and the pressure roller 66. Hence, including error factors, according to this exemplary embodiment, the circumferential speed ratio of the circumferential speed of the heating roller 62 with respect to the circumferential speed of the pressure roller 66 is 102.5 plus-minus 1.5 percent.

In the fixing device 6, the fixing belt 65 is mainly driven and rotated by the pressure roller 66. Accordingly, even if the fixing belt 65 is driven and rotated by the pressure roller 66 only and the heating roller 62 is driven and rotated by the fixing belt 65, while the sheet P is not conveyed through the fixing nip N, the fixing belt 65 is immune from slippage. Alternatively, if the pressure roller 66 stops its rotation and only the heating roller 62 is driven and rotated, the fixing belt 65 does not rotate. Yet alternatively, if the heating roller 62 is driven and rotated while the pressure roller 66 is isolated from the fixing belt 65, the fixing belt 65 rotates but slips slightly.

A description is provided of tension exerted to the fixing belt 65.

It is necessary to stretch the fixing belt 65 taut across the heating roller 62 and the fixing pad 63 properly. FIG. 6 is a schematic vertical sectional view of the fixing device 6 illustrating the shape of the fixing belt 65. If the inner diameter of the fixing belt 65 is not greater than 25 mm, the fixing belt 65 including the polyimide base layer 65a having a thickness of 50 micrometers attains a predetermined tension due to the mechanical strength, that is, the internal stress, of the fixing belt 65 as the fixing belt 65 is deformed from a circle in cross-section illustrated in the broken line into an ellipse in cross-section illustrated in the solid line in FIG. 6.

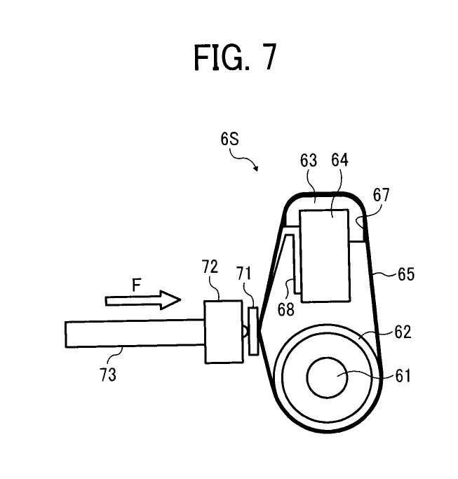

With reference to FIG. 7, a description is provided of a construction of a fixing device 6S according to another exemplary embodiment.

FIG. 7 is a schematic vertical sectional view of the fixing device 6S. As shown in FIG. 7, the fixing device 6S includes a plate spring 68 serving as a biasing member disposed opposite the inner circumferential surface of the fixing belt 65. For example, the plate spring 68 is mounted on the fixing stay 64 and biases against the fixing belt 65. A cleaning roller is disposed opposite an outer circumferential surface of the fixing belt 65. Thus, the plate spring 68 and the cleaning roller exert a predetermined tension to the fixing belt 65. If the tension is excessively great, a lateral end of the fixing belt 65 in an axial direction thereof may suffer from damage or breakage.

A description is provided of adhesion of the fixing belt 65 to the heating roller 62.

It is necessary to adjust an adhesion force that adheres the fixing belt 65 to the heating roller 62 properly. If the adhesion force that adheres the fixing belt 65 to the heating roller 62 is excessively small, a driving force generated by the driver 600 to drive and rotate the heating roller 62 is not transmitted from the heating roller 62 to the fixing belt 65, degrading motion of the fixing belt 65. Conversely, if the adhesion force that adheres the fixing belt 65 to the heating roller 62 is excessively great, a corner of the fixing pad 63 may bend the fixing belt 65, degrading motion of the fixing belt 65. A roundness R of the fixing pad 63 is not smaller than about 1 mm to prevent bending of the fixing belt 65.

It is impossible to measure the adhesion force that adheres the fixing belt 65 to the heating roller 62. To address this circumstance, as shown in FIG. 7, a portion of the fixing belt 65 where the fixing belt 65 is stretched taut across the plate spring 68 is disposed opposite a load cell 72 via a rigid plate 71. A micrometer 73 presses the load cell 72 against the plate spring 68 via the rigid plate 71 and the fixing belt 65 in a direction F to adjust a load in a range of from about 0.5 N/m to about 10.0 N/m, thus attaining a desired adhesion force that adheres the fixing belt 65 to the heating roller 62.

A description is provided of application of the lubricant.

The inner circumferential surface of the fixing belt 65 is applied with the lubricant such as silicone oil and grease to reduce friction between the fixing pad 63 and the like and the fixing belt 65 sliding thereover. Accordingly, the lubricant may be interposed between the heating roller 62 and the fixing belt 65. Since the heating roller 62 drives and rotates the fixing belt 65, in order to facilitate transmission of a driving force from the heating roller 62 to the fixing belt 65, a surface of the heating roller 62 has a surface roughness of about Ra 5 or smaller so that the heating roller 62 retains the lubricant readily. Various methods for increasing the surface roughness of the heating roller 62 are available: a method for increasing the surface roughness physically by sandblasting; a method for increasing the surface roughness chemically by etching; and a method for increasing the surface roughness by applying a coating mixed with small-diameter beads. Additionally, the inner circumferential surface of the fixing belt 65, that is, a contact face of the fixing belt 65 that contacts the heating roller 62, has a surface roughness not greater than about Ra 5.

According to the exemplary embodiments described above, the halogen heater 61 serving as a heater that heats the fixing belt 65 is situated inside the heating roller 62. Alternatively, instead of or in addition to the halogen heater 61 located inside the heating roller 62, a heater may be disposed inside the pressure roller 66 or mounted on the fixing stay 64. Yet alternatively, other heaters that heat the fixing nip N may be employed. According to the exemplary embodiments described above, the heating roller 62 and the fixing pad 63 serve as a plurality of supports that supports the fixing belt 65. Alternatively, an extra roller or an alternative roller, instead of the fixing pad 63, may serve as a support that supports the fixing belt 65 or another roller, instead of the heating roller 62, may serve as a driving rotator that drives and rotates the fixing belt 65 while supporting the fixing belt 65. According to the exemplary embodiments described above, the fixing pad 63 serves as a nip formation member. Alternatively, a roller may serve as a nip formation member.

The exemplary embodiments described above attain advantages below in a plurality of aspects A to K.

In the aspect A, a fixing device (e.g., the fixing devices 6 and 6S) includes an endless fixing rotator (e.g., the fixing belt 65) rotatable in a predetermined direction of rotation; a plurality of supports (e.g., the heating roller 62 and the fixing pad 63) rotatably supporting the fixing rotator; and a pressure rotator (e.g., the pressure roller 66) disposed opposite the fixing rotator and pressed against an outer circumferential surface of the fixing rotator. The pressure rotator drives and rotates the fixing rotator. One of the plurality of supports includes a nip formation member (e.g., the fixing pad 63) pressing against the pressure rotator via the fixing rotator to form the fixing nip N between the fixing rotator and the pressure rotator, through which a sheet P, serving as a recording medium, bearing a toner image T is conveyed. A heater (e.g., the halogen heater 61) is disposed opposite the fixing rotator to heat the fixing rotator. As the sheet P bearing the toner image T is conveyed through the fixing nip N, the fixing rotator and the pressure rotator fix the toner image T on the sheet P under heat and pressure. Another one of the plurality of supports includes a driving rotator (e.g., the heating roller 62) that drives and rotates the fixing rotator. A circumferential speed, that is, a surface movement speed, of the driving rotator is greater than a circumferential speed of the pressure rotator.

Accordingly, the fixing rotator is driven and rotated by the pressure rotator and the driving rotator, thus being rotatable in accordance with rotation of the pressure rotator and the driving rotator. Consequently, even when the sheet P conveyed through the fixing nip N obstructs transmission of a driving force from the pressure rotator to the fixing rotator, another driving force is transmitted from the driving rotator rotating at the circumferential speed greater than the circumferential speed of the pressure rotator to the fixing rotator, thus suppressing degradation in motion of the fixing rotator to convey the sheet P. As a result, the fixing device suppresses slippage of the sheet P caused by a difference between a conveyance speed of the pressure rotator that conveys the sheet P and a conveyance speed of the fixing rotator that conveys the sheet P.

In the aspect B, according to the fixing device in the aspect A, the circumferential speed of the driving rotator is greater than the circumferential speed of the pressure rotator by a range of from 1 percent to 10 percent.

Accordingly, the driving rotator rotating at the circumferential speed defined above suppresses degradation in motion of the fixing rotator that conveys the sheet P through the fixing nip N. Additionally, even if the fixing rotator slides over the plurality of supports, the fixing rotator is immune from damage, resulting in long term use of the fixing rotator.

In the aspect C, according to the fixing device in the aspect A or B, the driving rotator includes a heating roller accommodating a heater (e.g., the halogen heater 61).

Accordingly, the driving rotator rotatably supports the fixing rotator and at the same time transmits heat generated by the heater to the fixing rotator, unnecessitating an extra support that supports the fixing rotator or a space accommodating the heater and thereby reducing manufacturing costs.

In the aspect D, according to the fixing device in the aspect A, B, or C, the fixing rotator includes a base (e.g., the base layer 65a) made of polyimide.

Accordingly, the base made of polyimide is manufactured at decreased costs compared to a base made of metal, downsizing the fixing rotator.

In the aspect E, according to the fixing device in the aspect A, B, C, or D, the driving rotator includes a metal roller having a surface roughness not greater than Ra 5.

Accordingly, the driving rotator having a slightly roughened surface readily retains a lubricant or the like that reduces friction between the nip formation member and the fixing rotator sliding thereover.

In the aspect F, according to the fixing device in the aspect A, B, C, D, or E, a slide sheet (e.g., the slide sheet 67) applied with the lubricant is interposed between the fixing rotator and the nip formation member.

Accordingly, the slide sheet reduces friction between the nip formation member and the fixing rotator sliding thereover, resulting in long term use of the fixing rotator and the nip formation member.

In the aspect G, according to the fixing device in the aspect A, B, C, D, E, or F, an identical driver (e.g., the driver 600) drives and rotates the pressure rotator and the driving rotator.

Accordingly, the driver unnecessitates an extra support that drivably supports the fixing rotator or a space accommodating a plurality of drivers, reducing manufacturing costs.

In the aspect H, according to the fixing device in the aspect A, B, C, D, E, F, or G, the fixing rotator is exerted with a tension not smaller than a predetermined value by the mechanical strength of the driving rotator, the nip formation member, or the fixing rotator.

Accordingly, a driving force that drives and rotates the fixing rotator is transmitted from the driving rotator and the pressure rotator to the fixing rotator precisely.

In the aspect I, according to the fixing device in the aspect H, a biasing member (e.g., the plate spring 68) contacts the fixing rotator to exert a tension to the fixing rotator.

Accordingly, a driving force that drives and rotates the fixing rotator is transmitted from the driving rotator and the pressure rotator to the fixing rotator precisely.

In the aspect J, an image forming apparatus (e.g., the image forming apparatus 10) includes an image forming device (e.g., the process cartridge 2) that forms a toner image T on a sheet P serving as a recording medium and a fixing device (e.g., the fixing devices 6 and 6S) in the aspect A, B, C, D, E, F, G, H, or I that fixes the toner image T on the sheet P.

Accordingly, the fixing device suppresses slippage of the sheet P, preventing faults such as jamming of the sheet P and image noise.

In the aspect K, according to the image forming apparatus in the aspect J, the image forming device forms the toner image T on the sheet P with toner containing oily silica as an additive.

Accordingly, the image forming apparatus enhances fixing quality of the fixing device.

According to the exemplary embodiments described above, the fixing belt 65 serves as a fixing rotator. Alternatively, a fixing film, a fixing sleeve, or the like may be used as a fixing rotator. Further, the pressure roller 66 serves as a pressure rotator. Alternatively, a pressure belt or the like may be used as a pressure rotator.

The present disclosure has been described above with reference to specific exemplary embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. A fixing device comprising:
an endless fixing rotator rotatable in a predetermined direction of rotation;
a heater disposed opposite the fixing rotator to heat the fixing rotator;
a pressure rotator pressed against an outer circumferential surface of the fixing rotator to drive and rotate the fixing rotator;
a nip formation member pressing against the pressure rotator via the fixing rotator to form a fixing nip between the fixing rotator and the pressure rotator, through which a recording medium bearing a toner image is conveyed, the nip formation member to support the fixing rotator; and
a driving rotator, supporting the fixing rotator, to drive and rotate the fixing rotator, the driving rotator to rotate at a circumferential speed greater than a circumferential speed of the pressure rotator.

2. The fixing device according to claim 1, wherein the circumferential speed of the driving rotator is greater than the circumferential speed of the pressure rotator by a range of from 1 percent to 10 percent.

3. The fixing device according to claim 1, wherein the driving rotator includes a heating roller accommodating the heater.

4. The fixing device according to claim 1, wherein the fixing rotator includes a base made of polyimide.

5. The fixing device according to claim 1, wherein the driving rotator includes a metal roller having a surface roughness not greater than Ra 5.

6. The fixing device according to claim 5, wherein an inner circumferential surface of the fixing rotator has a surface roughness not greater than Ra 5.

7. The fixing device according to claim 1, further comprising a slide sheet applied with a lubricant and interposed between the fixing rotator and the nip formation member.

8. The fixing device according to claim 7, wherein the lubricant includes one of grease and silicone oil and is interposed between an inner circumferential surface of the fixing rotator and the slide sheet.

9. The fixing device according to claim 1, wherein the fixing rotator is exerted with a tension not smaller than a predetermined value by a mechanical strength of at least one of the driving rotator, the nip formation member, and the fixing rotator.

10. The fixing device according to claim 1, further comprising a biasing member contacting the fixing rotator to exert a tension to the fixing rotator.

11. The fixing device according to claim 10, wherein the biasing member includes a plate spring.

12. The fixing device according to claim 11, further comprising a fixing stay contacting and supporting the nip formation member,
wherein the plate spring is mounted on the fixing stay and biased against the fixing rotator.

13. The fixing device according to claim 1, wherein the fixing rotator includes an endless fixing belt stretched taut across the nip formation member and the driving rotator.

14. The fixing device according to claim 1, wherein the pressure rotator includes a pressure roller.

15. The fixing device according to claim 1, wherein the nip formation member includes a fixing pad.

16. An image forming apparatus comprising:
an image forming device to form a toner image on a recording medium; and
a fixing device, disposed downstream from the image forming device in a recording medium conveyance direction, to fix the toner image on the recording medium,
the fixing device including:
an endless fixing rotator rotatable in a predetermined direction of rotation;
a heater disposed opposite the fixing rotator to heat the fixing rotator;
a pressure rotator pressed against an outer circumferential surface of the fixing rotator to drive and rotate the fixing rotator;
a nip formation member pressing against the pressure rotator via the fixing rotator to form a fixing nip between the fixing rotator and the pressure rotator, through which the recording medium bearing the toner image is conveyed, the nip formation member to support the fixing rotator; and
a driving rotator, supporting the fixing rotator, to drive and rotate the fixing rotator, the driving rotator to rotate at a circumferential speed greater than a circumferential speed of the pressure rotator.

17. The image forming apparatus according to claim 16, wherein the image forming device forms the toner image on the recording medium with toner containing oily silica as an additive.

18. The image forming apparatus according to claim 16, further comprising a driver to drive and rotate the pressure rotator and the driving rotator of the fixing device.
